(19) United States
(12) Patent Application Publication
(10) Pub. No.: US 2004/0062392 A1
(43) Pub. Date: Apr. 1, 2004

(54) Central automated transmission system for broadcasting and method of operating

(75) Inventor: Larry E. Morton, Little Rock, AR (US)

Correspondence Address: ARENT FOX KINTNER PLOTKIN & KAHN, 1050 CONNECTICUT AVENUE, N.W., SUITE 400, WASHINGTON, DC, 20036, US

(73) Assignee: EQUITY BROADCASTING GROUP INC.

(21) Appl. No.: 10/673,998

(22) Filed: Sep. 30, 2003

Related U.S. Application Data
(60) Provisional application No. 60/414,625, filed on Oct. 1, 2002.

(51) Int. Cl. H04N 7/167

(52) U.S. Cl. 380/200

(57) ABSTRACT

A broadcasting system for receiving a plurality of programs from different programming sources having a plurality of first receivers for receiving the plurality of programs as analog and digital signals. The master control unit includes an analog to digital converter, a storage server, a plurality of playback stations, compression and encryption processors, a multiplexer and a control unit. The control unit is adapted to provide programming instructions to store, process, compress, encrypt, monitor and generate an output signal comprising the plurality of programs in a predetermined format. A transmitter that is coupled to the master control unit transmits the output signal to a plurality of second receivers. The master control unit continues monitoring the output signal after it is received by the plurality of second receivers. The generated output signal provides a combination of the plurality of programs received from different programming sources in a single channel.

This application claims the benefit of U.S. Provisional Patent Application, No. 60/414,625, filed Oct. 1, 2002, the disclosure of which is incorporated herein.

### BACKGROUND OF THE INVENTION

1. Field of the Invention

The present invention relates generally to the field of broadcasting systems. More particularly, the present invention relates to an integrated broadcasting system and method of operating a myriad of satellite uplink/downlink systems and integrating them with a single master control unit, which provides an improved automation for the transmission of digital programming.

2. Description of the Related Art

In conventional broadcasting systems, a broadcaster such as the Cable News Network (CNN) or American Broadcasting Corporation (ABC) typically develop programs that are transmitted via satellite, cable, or videotape to their affiliates located in various regions. These programs are generally received by a local broadcasting affiliate then redistributed to viewers. These local affiliates typically have the means to provide a single channel for each broadcaster. For instance, CNN generates a program and transmits the programs via cable to the local cable affiliate. The local affiliate then assigns a single channel to CNN. A viewer, who has purchased the CNN programming, receives that particular channel. Thus, the affiliate functions as a broadcast center or a central hub, which processes the programs that are received as analog signals and rebroadcasts the programs to viewers and/or other broadcast centers via satellite, cable, or videotape.

As broadcasting systems have utilized satellite and digital technology, broadcasting programs have become more cost effective and efficient for programming sources. However, the costs for local broadcasting centers have increased because of the amount of programs being provided and the constraints due to the cost of re-broadcasting. Thus, the increasing requirements for a realizable cost effective multi-channel digital transmission system are placing a considerable strain on the broadcaster to implement dynamic and responsive multi-channel transmission system. The programs provided by the programming sources are processed by many different affiliates rather than processed and distributed by a central broadcasting facility. Therefore, uniformity is missing in the reliability and quality of the programs that are rebroadcast from the local broadcasting stations, since the different broadcasting centers utilize different broadcasting systems.

As a result, there is a need for a highly-automated broadcasting system that controls the receiving and integration of satellite-delivered syndicated programs, combining program downlink operations into a central location that allows the ability to monitor and control the quality of broadcasts appearing on all stations. Also there is a need for a multi-channel broadcasting system that is capable of providing a combination of programs received from different programming sources in a single channel.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with one aspect of the present invention, there is provided a broadcasting system for receiving a plurality of programs from different programming sources. The broadcast system includes a plurality of first receivers for receiving the plurality of programs as analog and digital signals. A master control unit is coupled to the plurality of receivers. The master control unit includes an analog to digital converter, a storage server, a plurality of playback stations, compression and encryption processors, a multiplexer and a control unit. The control unit is adapted to provide programming instructions to store, process, compress, encrypt, monitor and generate an output signal comprising the plurality of programs in a predetermined format. A transmitter is coupled to the master control unit for transmitting the output signal to a plurality of second receivers. The master control unit continues monitoring the output signal after the signals are received by the plurality of second receivers. The output signal provides a combination of the plurality of programs received from different programming sources in a single channel.

In accordance with another aspect of the present invention, there is provided a broadcasting method including the steps of receiving a plurality of programs from different programming sources in a plurality of first receivers coupled to a master control unit. The plurality of programs are received as analog or digital signals. The method also includes the steps of converting analog signals to digital signals; storing the analog and digital signals; routing the digital signals to a multi-channel video server and a plurality of playback stations based on a programming format; processing the digital signals received from different programming sources according to the programming format controlled by a control unit; compressing and encrypting the processed digital signals; transmitting a single output signal comprising the processed digital signals according to the programming format to a plurality of second receivers; and monitoring the plurality of programs received in the master control unit and the output signal transmitted from the master control unit.

In accordance with still another aspect of the present invention, there is provided a master control unit coupled to a plurality of receivers and a transmitter. The master control unit is adapted to receive a plurality of programs from different programming sources. The master control unit includes a digitizing means for converting analog signals to digital signals, a storing means for storing the digital signals, a processing means for editing and formatting the digital signals, compressing and encryption means for compressing and encrypting the digital signals. The master control also includes a multiplexing means for multiplexing the digital signals received from the processing means and outputting a single output signal and a control means for monitoring, routing and processing the digital signals based on a predetermined format.

In accordance with yet another aspect of the present invention, there is provided a master control unit coupled to a plurality of first receivers for receiving programming feeds from a plurality of programming sources. A transmitter is used to output a processed programming signal to a plurality of second receivers. The master control unit includes a plurality of input storage devices for storing the programming feeds received from the plurality of receivers as analog and digital signals. An analog-to-digital converter coupled to the plurality of input storage devices converts the analog signals to digital signals. A digital router coupled to the plurality of input storage devices and the analog-to-digital converter directs the digital signals stored in the plurality of input storage devices and the digital signals received from the analog-to-digital converter. At least one storage server is coupled to the digital router for storing the digital signals. A plurality of playback stations coupled to the at least one storage server and the digital router formats and edits the digital signals according to predetermined programming format. At least one compression/encryption processor is coupled to the digital router and the plurality of playback stations compresses and encrypts each one of the digital signals processed by the plurality of playback stations. At least one multiplexer is coupled to the at least one compression/encryption processor for multiplexing the digital signals. The multiplexer outputs a single output signal and transmits the output signal to the transmitter. At least one control unit is coupled to the plurality of input storage devices, the analog-to-digital converter, the digital router, the at least one storage server, the plurality of playback stations, the at least one compression/encryption processor and the at least one multiplexer. At least one control unit is configured to monitor, control and process all analog and digital signals transmitted through the master control unit.

In accordance with yet another aspect of the present invention, there is provided a broadcasting system for receiving a plurality of programs from different programming sources having a plurality of first receivers receiving the plurality of programs as analog and digital signals and coupled to a master control unit. The master control unit includes an analog-to-digital converter coupled to the plurality of receivers, for converting the analog signals to digital signals; a multi-channel server coupled to the analog-to-digital converter and the plurality of receivers, the multi-channel server stores the digital signals received by the plurality of first receivers and the digital signals transmitted from the analog-to-digital converter. A plurality of playback stations are coupled to the multi-channel server and the analog to digital converter. The plurality of playback stations edit, monitor, format, and position the plurality of programs according to a predetermined programming format. The master control unit also includes compression and encryption processors coupled to the plurality of playback stations. The compression and encryption processors compress and encrypt the digital signals received from each one of the plurality of playback stations. A multiplexer, coupled to the compression and encryption processors, multiplexes the digital signals received from the compression and encryption processors. A control unit is adapted to provide programming instructions to store, process, compress, encrypt, monitor and generate an output signal comprising the plurality of programs in the predetermined programming format. A digital router is coupled to the analog-to-digital converter, each one of the plurality of playback stations, the compression and encryption processors and the multiplexer for routing the digital signals. A satellite uplink-transmitter is coupled to the master control unit for transmitting an output signal to a plurality of second receivers. The control unit of the master control unit monitors the output signal received by the plurality of second receivers. The output signal provides a plurality of processed programs in a single channel.

In accordance with another aspect of the present invention, there is provided a broadcasting method including the steps of receiving a plurality of programs from different programming sources in a plurality of first receivers coupled to a master control unit, the plurality of programs received in the master control unit as analog or digital signals; converting the analog signals to digital signals; transmitting the digital signals from an analog to digital converter to a multi-channel video server; storing the digital signals in the multi-channel video server; routing the digital signals to a multi-channel video server and a plurality of playback stations based on a programming format; controlling the routing of the digital signals through a digital router coupled to the plurality of first receivers, the analog-to-digital converter, the multi-channel video server, the plurality of playback stations, compression and encryption processors, and a multiplexer; processing the plurality of programs in a master control unit through the programming format provided by a control unit, and preparing the predetermined programming format using the plurality of playback stations; compressing and encrypting the processed digital signals received from the plurality of playback stations; multiplexing the compressed and encrypted digital signals to output a single output signal; transmitting the single output signal through an unlink-transmitter comprising the processed digital signals according to the predetermined programming format to a plurality of second receivers; and monitoring the plurality of programs received in the master control unit and the single output signal transmitted from the master control unit.

### BRIEF DESCRIPTION OF THE DRAWINGS

The objects and features of the invention will be more readily understood with reference to the following description and the attached drawings, wherein:

FIG. 1 is a block diagram according to an exemplary embodiment of the present invention;

FIG. 2 is a block diagram of the master control unit of the present invention in another exemplary embodiment of the present invention;

FIG. 3 is a flowchart showing the steps for processing the signals according to the embodiment shown in FIG. 2;

FIG. 4 is block diagram illustrating the features of a master control unit according to yet another exemplary embodiment of the present invention;

FIG. 5 is a detailed flowchart showing the steps of a broadcasting method according an exemplary embodiment of the present invention; and

FIG. 6 is a block diagram illustrating the master control unit utilized in according to yet another exemplary embodiment of the present invention.

### DETAILED DESCRIPTION OF THE DRAWINGS

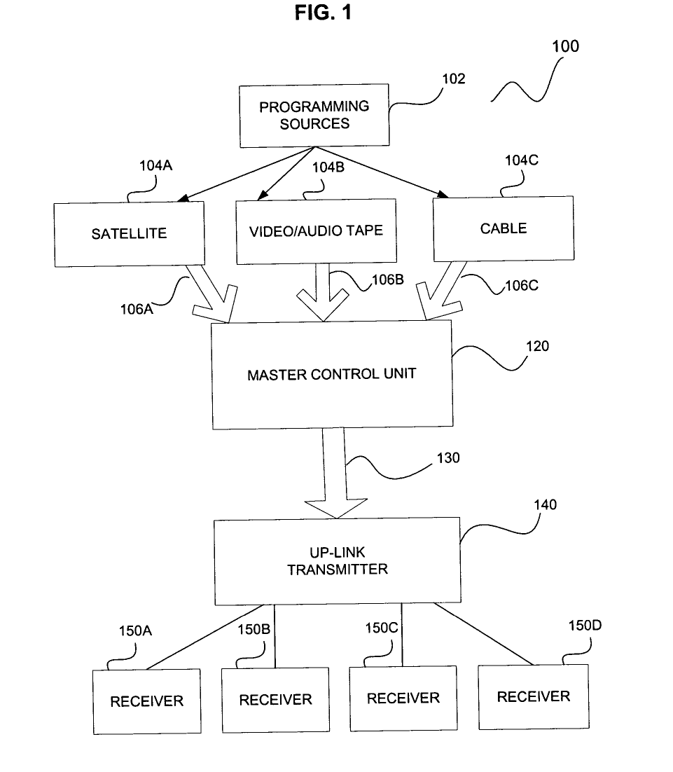

Referring to FIG. 1, a block diagram illustrates an exemplary automated broadcasting transmission system 100 according to one embodiment of the present invention. The broadcasting transmission system 100 receives multiple network and syndicated programming feeds at a central location, inserts commercials, infomercials and local emergency access system feeds in the syndicated programming and creates a single local station signal. The broadcast transmission system 100 can control the receiving and the integration of satellite-delivered syndicated programs. Thus, combining program down link operations into one central location enables this exemplary embodiment of the present invention to closely monitor and control the quality of broadcasting appearing on all channels. Also, system 100 enables an operator the ability to combine different programs received from various programming sources into a single channel.

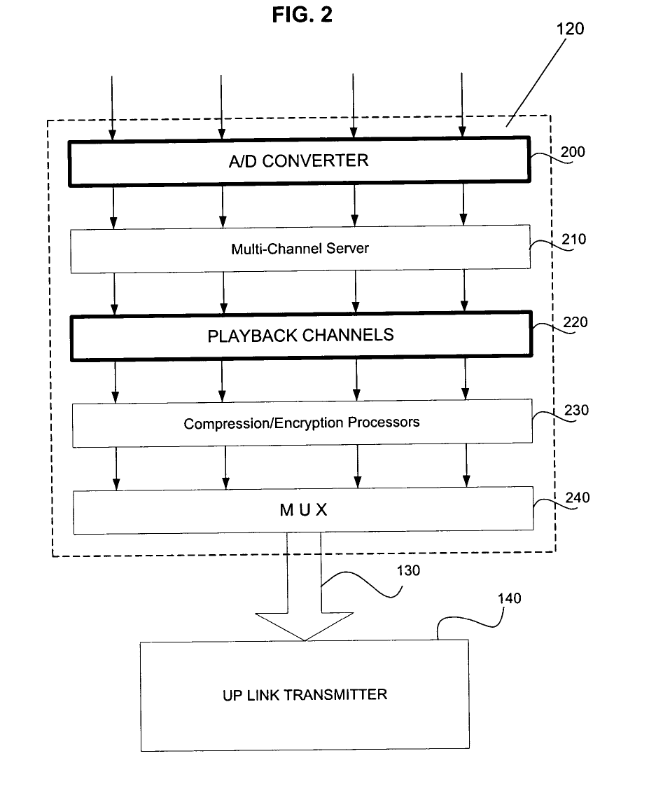

Video and audio signals are generally broadcasted from programming sources 102 via satellite 104A, videotape 104B, and/or cable 104C. However, programming sources 102 may broadcast the video and audio signals in any format. Programming sources 102 provide the broadcasting transmission system 100 programming feeds using analog or digital signals and by way of videotape, cable, and/or satellite. Programs transmitted by the programming sources 102 can be transmitted as digital or analog signals 106A, 106B, and 106C and are transmitted via satellite 104A, video/audio tape 104B and/or cable 104C. These signals 106A, 106B, 106C are received in a master control unit 120. The master control unit 120, as described in more detail in reference to FIGS. 2-6, processes signals 106A-C received from the programming sources 102.

In a preferred embodiment of the present invention, the master control unit 120 processes, stores, distributes, and controls all programs received from the multiple programming sources in accordance with an exemplary method. Once these signals are processed and multiplexed, a single digital signal 130 is transmitted to an uplink-transmitter 140. The single digital signal 130 is then re-transmitted to receivers 150A-150B, which can be local cable operators, television station operators, or direct subscribers.

Referring now to FIG. 2, a more detailed description of the master control unit 120 is illustrated. The master control unit 120 includes an analog to digital converter 200, a multi-channel server 210, playback stations 220, data compression/encryption processors 230, and a multiplexer 240. Signals or programming feeds are received into the master control unit 120, generally as analog signals. However, digital signals are also received if the broadcasters/programming sources transmit in that format. The analog signals are converted to digital signals by the analog-to-digital converter 200. These digitized signals are then stored in the multi-channel server 210. Next, these digitized signals stored in the server 210 are transmitted to the playback stations 220. In one exemplary embodiment, 60 playback stations can be used to process 60 different programs simultaneously. It should be noted that the present invention is not limited by the number of playback stations 220. Playback stations 220 are used to combine, edit, format and schedule programming feeds according to a programming format determined by operators. Thus, the traffic of all programs received can be automated or controlled manually by operators.

Once the programming feeds are processed by the playback stations 220, compression and encryptions processors 230 are used to compress and encrypt the signals. The compressed and encrypted signals are then transmitted to a multiplexer 240. The multiplexer 240 combines all the signals from each playback stations and generates a single output signal. The single output signal 130 is then transmitted to an uplink transmitter 140.

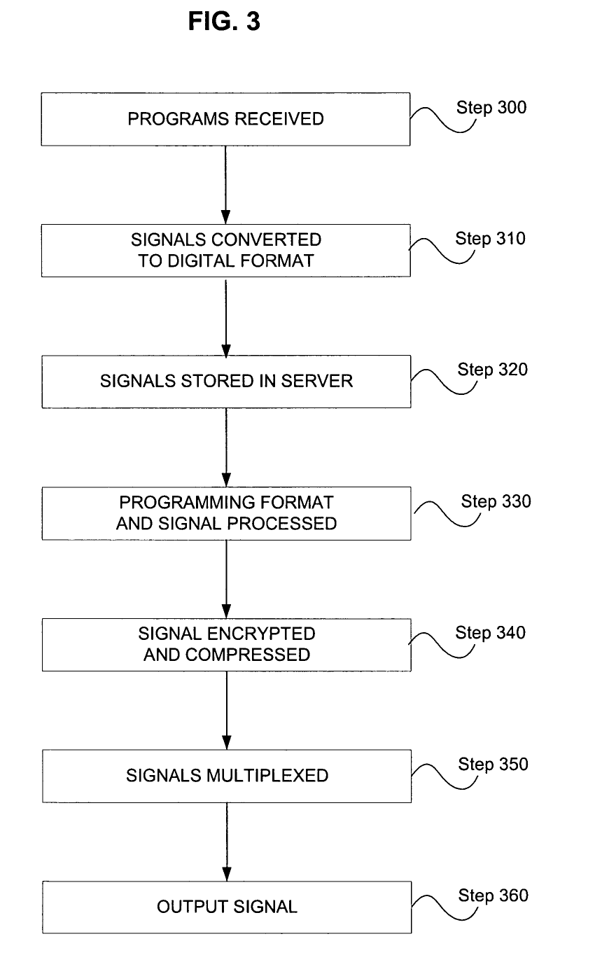

FIG. 3 is a flowchart illustrating the processing of programs received by the master control unit 120 according to FIG. 2. Programs that are received (step 300) are initially converted from analog to digital by the analog-to-digital converter 200, if the signals are received in an analog format. Once the signals are converted to digital signals (Step 310), the signals are stored in the multi-channel server 210 (Step 320). Next, operators utilize a predetermined programming format, for instance which program and the order for the program to be viewed (timing), to process the programs by using the playback stations 220 (Step 330). Once the programs are edited, clipped, monitored, and reviewed using the playback stations 220, the signals are encrypted and compressed using the compression and encryption processors 230 (Step 340). The process of compression and encryption can be accomplished by a variety of known compression and encryption procedures. The present invention is not limited by the number of compression and encryption processors or the types of processing methods. Thus, each individual signal from each playback stations 220 is compressed and encrypted. Once each one of the signals received from each one of the playback stations 220 are compressed and encrypted, the signals are multiplexed by a multiplexer 240 (Step 350). The multiplexer 240 generates an output signal, which is transmitted to the uplink transmitter 140 (Step 360).

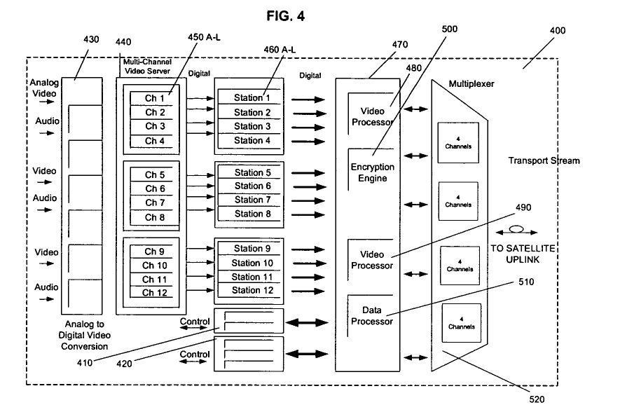

FIG. 4 illustrates yet another exemplary embodiment of the present invention. A master control unit 400 is illustrated having control stations 410 and 420. Master control unit 400 is also shown comprising a plurality of analog-to-digital converters 430, and a multi-channel video server 440 containing channels 450A-L, and playback stations 460A-L.

The master control unit 400 also includes compressing and encryption processors 470. The compression and encryption processors 470 further include first and second video processors 480, 490, an encryption engine 500, and a data processor 510. A multiplexer 520 having the capability to multiplex up to 16 channels is also illustrated. Master control unit 400 enables the computer monitoring and control of multiple signals through a single facility, with the bandwidth of each playback stations 460A-L constantly monitored and thereby the entire broadcasting system is assured adequate spacing between channels. The multiplexer 520 constantly monitors and controls the allocation of the 27 MB of bandwidth among the multiple broadcast signals through the fixed-based uplink.

Control stations 410 and 420 provide a programming schedule/format automation, server encoding, file segmenting, clip preparation, and scheduling router events. Control stations 410 and 420 govern the multi-channel playout, insert the commercials and monitor the playout duties of all the affiliates receiving the output signal.

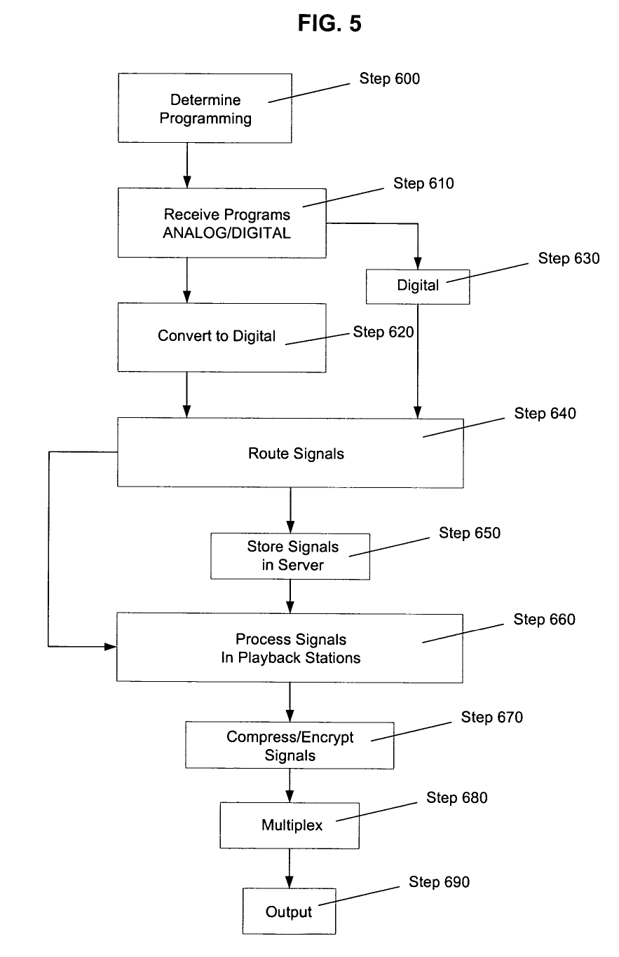

FIG. 5 is flowchart showing the steps for processing programs that are received in a broadcasting system having a master control unit according to an exemplary embodiment of the present invention, as shown in FIG. 4. Initially, operators determine programming traffic and format that is eventually broadcasted to viewers (Step 600). In one example, control stations 410 and 420 control and monitor all operations of the master control unit and the broadcasting system. For instance, the scheduling of programs, insertion of commercials and other editing features are controlled by control stations 410 and 420. In addition, control stations 410, 420 can be automated or can be manually operated. Thus, the master control unit 400 can be operational 24 hours a day.

Programs are typically received as analog signals (Step 610). However, the advances in digital technology have increased the development of broadcasting in digital format. If the programming feeds are received in analog format, these signals are then converted to digital signals using an analog to digital converter 430 (Step 620). The programming feeds that are received in digital format (Step 630) and the converted analog signals are then routed by a digital router controlled by control stations 410 and 420 to a multi-channel audio/video server 450A-L (Step 650). The router can also directly transmit the digitized signals directly to a plurality of playback stations 460A-L (Step 660). The playback stations 660 are used to edit, monitor, and generally process the digitized signals. After the control stations 410, 420 provide the programming format, the appropriate signals from each playback stations 460A-L are transmitted to compression/encryption processors 470 from the playback stations 460A-L (Step 670). The digitized signals are then compressed in a Moving Pictures Experts Group format (MPEG-2), however, the present invention is not limited to this compression method. Other compression formats may be suitable as desired. The compression processors compress the signals received from each playback station 460A-L, thereby, reducing the bandwidth that each video signal occupies. An encryption processor 500 encodes the digitized signals for security purposes.

The compressed and encrypted signals are then transmitted to a multiplexer 520 (Step 680). Multiplexer 520 assigns each compressed digital signal to a specific channel number. All the incoming signals from each playback stations 460A-L are then combined into one transport stream or digital output signal and transmitted to a satellite uplink transmitter for distribution (Step 690).

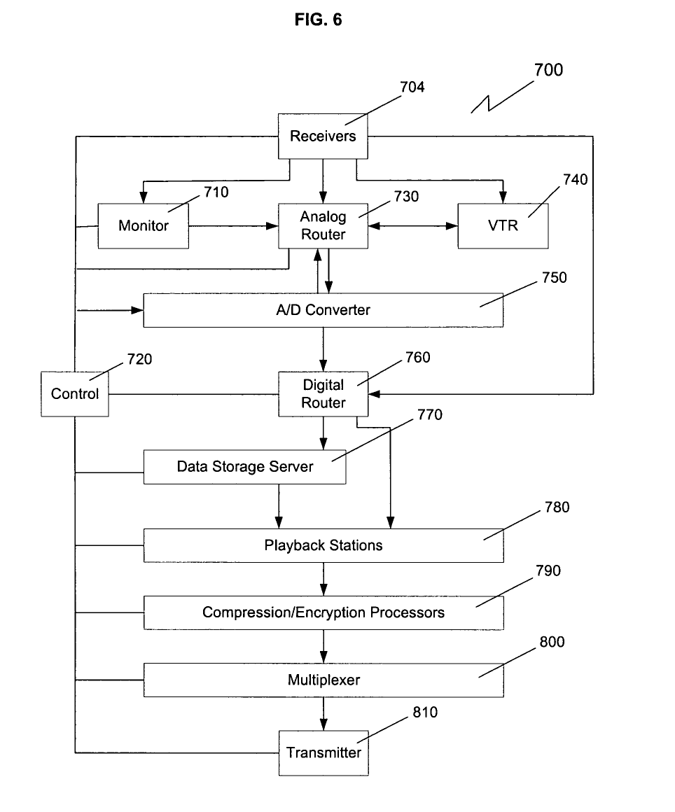

FIG. 6 is block diagram illustrating yet another exemplary embodiment of the present invention. Master control unit 700 receives programming feeds from various programming sources. Receivers 704 receive these programming feeds as either digital or analog signals via satellite transmission, cable, videotape, compacts disks or digital versatile disks. All programming feeds are monitored through a monitoring device 710 that is operated and controlled by a control unit 720. Signals received as analog signals are directed to an analog router 730 or temporarily stored in devices such as video tape recorders 740 (VTR). The analog router 730 directs all analog signals either stored in the VTR or directly received from the receivers 704 to an analog-to-digital converter 750. The analog-to-digital converter converts analog signals to digital signals and then transmits the digitized programming feeds or signals to a digital router 760. Programming feeds that are transmitted to the receivers 704 in a digital format are directed directly to the digital router 760. The control unit 720 monitors and controls all signals received and transmitted from the analog router 730 and the digital router 760.

Next, the digitized signals can be directed to a data storage server 770 or directly to a plurality of playback stations 780. These digitized signals are routed based on instructions from the control unit 720. The playback stations 780 are used to edit the programming feeds according to the operators' instructions. For instance, a clip for a specific program that is received after the initial program is transmitted can be edited into the initial program. The control unit 720 monitors and controls all the programming feeds to maintain the quality and efficiency of the broadcasting system. The playback stations 780 are also utilized to structure a programming schedule according to a predetermined format via the control unit 720. In addition, programming feeds from different programming sources can be added into a single channel for distribution. For instance, a CNN program and an ABC program can be provided on the same channel by utilizing the features of the present invention.

Once the programming format is executed, the digitized signals are transmitted from the playback stations 780 to compression and encryption processors 790. The compression processors 790 in this embodiment utilize an MPEG-2 format. The MPEG-2 enables the transmission of multiple programs in the same space as a single analog transmission. In addition, the compression of these digitized signals offers much more programming versus analog signals with the same amount of bandwidth. The compressed signals are also encrypted for security purposes. Therefore, only subscribers to that channel can decode the encrypted signal. Other compression procedures suitable for broadcasting systems can also be used.

The compressed and encrypted signals are transmitted to a multiplexer 800. The multiplexer 800 receives each compressed and encrypted signal and assigns each signal to a specific channel number. All the signals received from the compression/encryption processors 790 are then combined into one output signal, which is transmitted to an uplink-transmitter 810.

The control unit 720 provides the instructions for the monitoring, processing, storing, distributing, and controlling the plurality of programming feeds from one central facility. In accordance with the exemplary embodiment of the present invention, an efficient multi-channel broadcasting system is provided that processes, stores, distributes, and controls multiple programming feeds from one broadcasting center. The location of the broadcaster center is irrelevant since each broadcasting affiliate can be contacted, monitored, and controlled by the output signal provided by the present invention.

Although a preferred embodiment of the present invention has been illustrated in the accompanying drawings and described in the foregoing detailed description, it will be understood that the invention is not limited to the embodiment disclosed, but is capable of numerous rearrangements, modifications and substitutions without departing from the spirit of the invention as set forth and defined by the following claims.

What is claimed is:

1. A broadcasting system for receiving a plurality of programs from different programming sources comprising:
a plurality of first receivers receiving the plurality of programs as analog and digital signals;
a master control unit coupled to the plurality of receivers, the master control unit comprising an analog to digital converter, a storage server, a plurality of playback stations, compression and encryption processors, a multiplexer and a control unit, the control unit adapted to provide programming instructions to store, process, compress, encrypt, monitor and generate an output signal comprising the plurality of programs in a predetermined format; and
a transmitter coupled to the master control unit transmitting the output signal to a plurality of second receivers,
wherein the master control unit continues monitoring the output signal after being received by the plurality of second receivers and the output signal provides comprising a combination of the plurality of programs received from different programming sources in a single channel.

2. The broadcasting system, as recited in claim 1, wherein the analog to digital converter is coupled to the plurality of receivers and converts the plurality of programs received as analog signals to digital signals.

3. The broadcasting system, as recited in claim 2, wherein the storage server is a multi-channel audio/video server for storing the digital signals.

4. The broadcasting system, as recited in claim 3, wherein the storage server is coupled to the analog to digital converter, the storage server being configured to store the digital signals received from the analog to digital converter.

5. The broadcasting system, as recited in claim 1, wherein the plurality of playback stations are used to edit, monitor, format, and position the plurality of programs in a single channel for the output signal.

6. The broadcasting system, as recited in claim 1, wherein the master control unit further comprises a digital router coupled to each one of the plurality of playback stations, storage server, the analog-to-digital converter, compression and encryption processors and the multiplexer for routing the digital signals.

7. The broadcasting system, as recited in claim 6, wherein the digital router is controlled and monitored by the control unit.

8. The broadcasting system, as recited in claim 1, wherein the compression and encryption processors are coupled to the playback stations the storage server, the multiplexer, and the digital router, the compression and encryption processors compress and encrypt the digital signals received from the playback stations or the storage server and transmit the compressed and encrypted signal to the multiplexer.

9. The broadcasting system, as recited in claim 7, wherein the multiplexer multiplexes the digital signals and outputs the output signal to the transmitter.

10. The broadcasting system, as recited in claim 9, wherein the control unit operably coupled to the transmitter monitors the output signal received by the plurality of second receivers.

11. The broadcasting system, as recited in claim 1, wherein the transmitter is a satellite uplink-transmitter.

12. The broadcasting system, as recited in claim 1, wherein the broadcasting system is located in a single central facility.

13. The broadcasting system, as recited in claim 1, wherein the broadcasting system is automated.

14. The broadcasting system, recited in claim 1, wherein the broadcasting system is manually operated.

15. A broadcasting method comprising the steps of:
receiving a plurality of programs from different programming sources in a plurality of first receivers coupled to a master control unit, the plurality of programs received in the master control unit are received as analog or digital signals;
converting the analog signals to digital signals;
storing the digital signals;
routing the digital signals to a multi-channel video server and a plurality of playback stations based on a programming format;
processing the digital signals received from different programming sources according to the programming format controlled by a control unit;
compressing and encrypting the processed digital signals;
transmitting a single output signal comprising the processed digital signals according to the programming format to a plurality of second receivers; and
monitoring the plurality of programs received in the master control unit and the single output signal transmitted from the master control unit.

16. A broadcasting method, as recited in claim 15, wherein the step of receiving the plurality of programs further comprises the step of monitoring the plurality of programs received from the different programming sources.

17. The broadcasting method, as recited in claim 15, wherein the step of converting analog signals to digital signals comprises the step of transmitting the digital signals from an analog to digital converter to a multi-channel video server.

18. The broadcasting method, as recited in 17, further comprises storing the digital signals in the multi-channel video server, the multi-channel video server being coupled to the analog-to-digital converter.

19. The broadcasting method, as recited in claim 15, wherein the step of routing the digital signals further comprises the step of controlling the routing of the digital signals through a digital router coupled to the plurality of first receivers, the analog-to-digital converter, the multi-channel video server, the plurality of playback stationss, compression and encryption processors, and a multiplexer.

20. The broadcasting method, as recited in claim 15, wherein the step of processing of the digital signals is automated.

21. The broadcasting method, as recited in claim 20, wherein the step of processing further comprises the step of preparing the predetermined programming format using the plurality of playback stations controlled by the control unit.

22. The broadcasting method, as recited in claim 21, wherein the step of processing the digital signals further comprises multiplexing the digital signals received from the plurality of playback stations to output the single output signal.

23. The broadcasting method, as recited in claim 15, wherein the step of transmitting further comprises transmitting the single output signal through an uplink-transmitter to the plurality of second receivers.

24. A master control unit coupled to a plurality of receivers and a transmitter, the master control unit being adapted to receive a plurality of programs from different programming sources comprising:
digitizing means for converting analog signals to digital signals;
storing means for storing the digital signals;
processing means for editing and formatting the digital signals;
compressing and encryption means for compressing and encrypting the digital signals;
multiplexing means for multiplexing the digital signals received from the processing means and outputting a single output signal; and
control means for monitoring, routing and processing the digital signals based on a predetermined format.

25. The master control unit, as recited in claim 24, wherein the digitizing means is an analog to digital converter.

26. The master control unit, as recited in 24, wherein the storing means is a multi-channel audio/video server.

27. The master control unit, as recited in claim 26, wherein the analog to digital converter transmits the digital signals to the multi-channel audio/video server.

28. The master control unit, as recited in claim 24, wherein the processing means includes monitoring, editing, formatting, and scheduling the digital signals in a plurality of playback stations.

29. The master control unit, as recited in claim 28, wherein the plurality of playback stations is controlled by the control means.

30. The master control unit, as recited in claim 29, wherein the control means controls traffic of the plurality of programs and formatting of the plurality of programs.

31. The master control unit, as recited in claim 15, wherein the control means is automated.

32. The master control unit, as recited in claim 15, wherein the control means is manually operated.

33. A master control unit operably coupled to a plurality of first receivers for receiving programming feeds from a plurality of programming sources, and a transmitter for outputting a processed programming signal to a plurality of second receivers, the master control unit comprising:
a plurality of input storage devices for storing the programming feeds received from the plurality of receivers as analog and digital signals;
an analog-to-digital converter coupled to the plurality of input storage devices for converting the analog signals to digital signals;
a digital router coupled to the plurality of input storage devices and the analog-to-digital converter for routing the digital signals stored in the plurality of input storage devices and the digital signals received from the analog-to-digital converter;
at least one storage server coupled to the digital router for storing the digital signals;
a plurality of playback stations coupled to the at least one storage server and the digital router for formatting and editing the digital signals according to predetermined programming format;
at least one compression/encryption processor coupled to the digital router and the plurality of playback stations for compressing and encrypting each one of the digital signals processed by the plurality of playback stations;
at least one multiplexer coupled to the at least one compression/encryption processor for multiplexing the digital signals and outputting a single output and transmitting the output single to the transmitter; and
at least one control unit coupled to the plurality of input storage devices, the analog-to-digital converter, the digital router, the at least one storage server, the plurality of playback stations, the at least one compression/encryption processor and the at least one multiplexer, the at least one control unit configured to monitor, control and process all analog and digital signals transmitted through the master control unit.

34. The master control unit, as recited in claim 33, wherein the plurality of input storage devices is at least one of video tape recorder, very small aperture terminal, a compact disk, and a digital versatile disk.

35. The master control unit, as recited in claim 33, wherein the programming feeds are received in the master control unit through at least one of satellite downlink transmission, cable, compact disk, digital versatile disk and videotape.

36. The master control unit, as recited in claim 33, wherein the storage server is a multi-channel audio/video server.

37. The master control unit, as recited in claim 33, wherein the master control unit is located in single central facility.

38. The master control unit, as recited in claim 33, wherein the master control unit is manually operated.

39. The master control unit, as recited in claim 33, wherein the master control unit is automated.

40. A broadcasting system for receiving a plurality of programs from different programming sources comprising:
a plurality of first receivers receiving the plurality of programs as analog and digital signals;
a master control unit coupled to the plurality of receivers, the master control unit comprising:
an analog-to-digital converter coupled to the plurality of receivers, for converting the analog signals to digital signals;
a multi-channel server coupled to the analog-to-digital converter and the plurality of receivers, the multi-channel server storing the digital signals received by the plurality of first receivers and the digital signals transmitted from the analog-to-digital converter;
a plurality of playback stations coupled to the multi-channel server and the analog to digital converter, edit, monitor, format, and position the plurality of programs according to a predetermined programming format;
compression and encryption processors coupled to the plurality of playback stations, compress and encrypt digital signals received from each one of the plurality of playback stations;
a multiplexer coupled to the compression and encryption processors multiplexes the digital signals received from the compression and encryption processors;
a control unit adapted to provide programming instructions to store, process, compress, encrypt, monitor and generate an output signal comprising the plurality of programs in the predetermined programming format;
a digital router coupled to the analog-to-digital converter, to each one of the plurality of playback stations, the compression and encryption processors and the multiplexer for routing the digital signals; and
a satellite uplink-transmitter coupled to the master control unit for transmitting an output signal to a plurality of second receivers; and
wherein the control unit monitors the output signal received by the plurality of second receivers and the output signal provides a plurality of processed programs in a single channel.

41. A broadcasting method comprising the steps of:
receiving a plurality of programs from different programming sources in a plurality of first receivers coupled to a master control unit, the plurality of programs received in the master control unit as analog or digital signals;
converting the analog signals to digital signals;
transmitting the digital signals from an analog to digital converter to a multi-channel video server;
storing the digital signals in the multi-channel video server;
routing the digital signals to a multi-channel video server and a plurality of playback stations based on a predetermined programming format;
controlling the routing of the digital signals through a digital router coupled to the plurality of first receivers, the analog-to-digital converter, the multi-channel video server, the plurality of playback stationss, compression and encryption processors, and a multiplexer;
processing the plurality of programs in a master control unit through the programming format provided by a control unit, and preparing the predetermined programming format using the plurality of playback stations;
compressing and encrypting the processed digital signals received from the plurality of playback stations;
multiplexing the compressed and encrypted digital signals to output a single output signal;
transmitting the single output signal through an unlink-transmitter comprising the processed digital signals according to the predetermined programming format to a plurality of second receivers; and
monitoring the plurality of programs received in the master control unit and the single output signal transmitted from the master control unit.
